(19) United States
(12) Patent Application Publication
(10) Pub. No.: US 2026/0332072 A1
(43) Pub. Date: Oct. 22, 2026

(54) TOOL AND METHOD FOR OPERATING A TOOL

(71) Applicant: ANDREAS STIHL AG & Co. KG, Waiblingen (DE)

(72) Inventors: Jan Lukas JACKENKROLL, Remseck (DE); Ingo KUGLER, Welzheim (DE); Daniel SCHWEIKER, Ludwigsburg (DE)

(73) Assignee: ANDREAS STIHL AG & Co. KG, Waiblingen (DE)

(21) Appl. No.: 19/649,385

(22) Filed: Apr. 16, 2026

(30) Foreign Application Priority Data
Apr. 17, 2025 (DE) 10 2025 115 168.7

(51) Int. Cl. H02P 6/28; H02P 6/18; H02P 25/03; H02P 27/08

(52) U.S. Cl. CPC H02P 6/28; H02P 6/18; H02P 25/03; H02P 27/08

(57) ABSTRACT

A tool comprising a drive unit for driving a tool element, at least one contact element for transmitting electrical energy and/or electrical signals, and an intermediate circuit that electrically connects the drive unit to the at least one contact element. The intermediate circuit comprises a switching module for the drive unit and a microprocessor module for controlling and/or regulating the switching module. The microprocessor module is configured to determine an interruption of a communication connection with the at least one supply device and, upon a determined interruption, to switch at least one switching unit of the intermediate circuit, in order to switch at least one contact element for transmitting electrical energy on the tool side to a voltage-free state and to impress a current present in the intermediate circuit into the drive unit for discharging the intermediate circuit. The invention further relates to a method for operating a tool.

### CROSS REFERENCE TO RELATED APPLICATIONS

This application hereby claims priority under 35 U.S.C. 119 from German Patent Application Serial No. DE 10 2025 115 168.7 filed on Apr. 17, 2025 the disclosure of which is hereby incorporated herein by reference in its entirety.

### DESCRIPTION

### Background of the Invention

The present invention is in the field of electric drive technology and relates to a tool, in particular a hand-held and/or portable power tool, with a drive unit for converting electrical energy to drive at least one tool element of the tool. The present invention further relates to a method for operating the tool.

Electrically powered tools (power tools) are used in many different areas and industries, for example, in the kitchen area, gardening, agriculture, and forestry, in the plant and process industry, or in the field of medical technology and building services engineering. To enable cordless and flexible handling, mobile hand-held tools, for example, are now often equipped with rechargeable accumulators that can provide stored electrical energy. A manually detachable plug-in connection or a manually detachable plug-in snap-in connection is usually formed between the tools and the accumulators, which should be easy to handle.

For the electrical connection of an accumulator, a tool has respective contact elements for corresponding mating contact elements of the accumulator. The contact elements of such tools are usually located in a plug-in section of the tool's housing in an exposed location. As a result, the contact elements are more or less freely accessible after the accumulator is disconnected from the tool.

### Summary

It is an object of the present invention to provide an electric tool that is characterized primarily by improved functionality during handling. Furthermore, it is an object of the present invention to provide a method for operating an electric tool which, in particular, ensures improved handling of the tool.

The object is achieved by the features of independent claims 1 and 11. Further embodiments and applications of the present invention result from the dependent claims and are explained in more detail in the following description with partial reference to the figures.

According to a first general aspect, the present invention relates to a tool, in particular a mobile and/or hand-held tool, comprising: • a drive unit with a stator and a rotor, which is configured to convert electrical energy to drive at least one tool element of the tool; • at least one contact element for transmitting electrical energy and/or electrical signals, which is configured to form a disconnectable terminal connection with at least one supply device for providing electrical energy and/or electrical signals, in order to be able to provide electrical energy and/or electrical signals to the drive unit in a connection state of the at least one supply device; • an intermediate circuit that electrically connects the drive unit to the at least one contact element, which comprises a switching module for the drive unit and a microprocessor module for controlling and/or regulating the switching module, wherein the microprocessor module is configured to determine an interruption, in particular an interruption process and/or an interruption state, of a communication connection with the at least one supply device, and, upon a determined interruption, to switch at least one switching unit of a current-limiting and/or voltage-control module of the intermediate circuit, which (the current-limiting and/or voltage-control module) is, in particular, arranged between at least one contact element for transmitting electrical energy and the switching module, in order to switch at least one contact element for transmitting electrical energy on the tool side to an essentially voltage-free state and/or to impress a current present in the intermediate circuit, in particular in the form of stored electrical energy, into the drive unit for discharging the intermediate circuit.

The present invention can provide a tool in the form of a power tool (electrical device), which is characterized by an extended functionality. In particular, a monitoring of a communication state between the at least one supply device and the microprocessor module can be realized, in order to determine an interruption-that is, an interruption process and/or an interruption state-in the event of such an occurrence and to realize a corresponding state with respect to the at least one contact element for transmitting electrical energy.

Due to the inventive configuration of the intermediate circuit (also referred to in abbreviated form as “DC link”), it is possible to determine an interruption of the communication connection with the at least one supply device even if the at least one supply device has not (yet) been disconnected from the tool. Furthermore, a voltage state and/or a charge state of the intermediate circuit can be determined and linked to the drive unit in such a way as to ensure a discharge of the intermediate circuit. In other words, the microprocessor module can be configured to monitor the communication connection with the at least one supply device and, upon a determined interruption of the communication connection, to control a corresponding switching operation within the intermediate circuit in order to switch at least one load contact element on the tool side to an essentially voltage-free state and, furthermore, in particular subsequently, to realize a discharge of the intermediate circuit via the drive unit.

The present invention, for example, goes a step further beyond the determination of a disconnection that is, a disconnection process and/or a disconnection state of the at least one supply device—and takes into account the communication state of the communication connection with the at least one supply device. This can be achieved, among other things, via at least one contact element of the tool for transmitting electrical signals and at least one mating contact element of the at least one supply device for transmitting electrical signals.

For example, it is possible that the microprocessor module is configured to initiate and/or execute a so-called handshake protocol with the at least one supply device, wherein a diagnostic communication signal and/or a readiness communication signal is sent to the at least one supply device and a corresponding response signal is received. An absence of a (confirming) response signal, in particular within a defined period of time, can be detected by the microprocessor module as at least one abnormal communication state.

The microprocessor module can additionally be configured to execute a timer function and/or a timeout function, which monitors the reception of an expected communication signal of the at least one supply device within a defined period of time. If the defined period of time is exceeded without the communication signal being received, this can be detected as a faulty and/or disrupted communication connection and thus as an abnormal communication state.

Additionally, the microprocessor module can be configured to compare defined communication parameters of received communication signals with defined communication reference parameters in order to detect an abnormal communication state in the event of a defined deviation.

Additionally, it is possible, that the microprocessor module is configured to monitor multiple communication channels with the at least one supply device essentially simultaneously, wherein a discrepancy between communication signals of different channels is used to detect an abnormal communication state.

The present invention makes it possible to draw a current present in the intermediate circuit in the form of stored electrical energy and/or to apply a voltage present in the intermediate circuit to the drive unit in order to transition the intermediate circuit to a discharged state.

The electrical energy within the intermediate circuit can be stored in at least one storage element of the intermediate circuit, which is configured to realize at least one of the following functions: storing electrical energy; smoothing a voltage fluctuation; filtering a voltage disturbance.

The switching operation can serve, among other things, to discharge the intermediate circuit with respect to and/or via the drive unit. The at least one switching unit of the current-limiting and/or voltage-control module can be arranged in a main line between the switching module and the at least one contact element for transmitting electrical energy. The at least one switching unit can comprise at least one switching element for realizing the switching function. The at least one switching element can, in particular, be formed as a semiconductor switching element, whereby switching operations can be performed in a comparatively very short period of time.

In other words, the intermediate circuit of the tool can be characterized by a circuit configuration and/or by a circuit logic to determine, in the course of an interruption, that is, an interruption process and/or an interruption state of the communication connection with the at least one supply device, an electrical voltage present in the intermediate circuit and to impress a current present in the intermediate circuit into the drive unit.

The at least one load contact element, which is switched essentially voltage-free, can be of significance as an exposed or freely accessible contact element, especially following an (actual) disconnection process of the at least one supply device.

A duration of the discharge, that is, the discharge process, can range, for example, from a few milliseconds to a maximum of a few seconds, depending on the electrical energy stored in the intermediate circuit.

With the present invention, parasitic properties, units, and/or elements (for example, resistors) of the drive unit can be utilized to set the intermediate circuit in an essentially current-free and/or voltage-free state when an interruption of the communication connection has already been determined by the microprocessor module.

The at least one contact element is, in particular, a load contact element for transmitting electrical energy. The intermediate circuit can further comprise at least one additional electrical/electronic unit (for example, a sensor unit), at least one additional electrical/electronic module (for example, a protection module), and/or at least one additional electrical/electronic element (for example, a rectifier element). The drive unit can, in particular, be a rotating-field machine in the form of a brushless three-phase motor and comprise a stator and a rotor.

The at least one supply device can be configured as a cell module with at least one cell (for example, at least one lithium-ion cell), as an assembly with a plurality of such cell modules, or as an accumulator with at least one cell module, in particular with a plurality of cell modules.

According to a further aspect of the present invention, it can be provided that the microprocessor module is configured, upon a determined interruption, in particular upon a determined interruption process and/or upon a determined interruption state, of the communication connection depending on at least one defined operating information, to identify a disconnection, in particular a disconnection process and/or a disconnection state, of the at least one supply device, and to switch the at least one switching unit at least (temporally) before the impressing of the current present in the intermediate circuit into the drive unit.

This ensures that, in the disconnection state of the at least one supply device, at least one exposed and/or freely accessible contact element in the form of a load contact element is always switched voltage-free before a disconnection process of the at least one supply device from the tool.

The at least one defined operating information can comprise at least one of the following: • a current transmission state of the at least one contact element for transmitting electrical energy during and/or after the determination of the interruption of the communication connection with the at least one supply device; • a voltage state of the at least one contact element for transmitting electrical energy and/or electrical signals during and/or after the determination of the interruption of the communication connection with the at least one supply device; • a voltage state of at least one storage element of the intermediate circuit, which is configured to realize at least one of the following functions: storing of electrical energy; smoothing of a voltage fluctuation, in particular with respect to voltage peaks and voltage dips; filtering of a voltage disturbance.

The current transmission state and/or the respective voltage state can, for example, each be a measured state.

A current transmitting state of the at least one contact element for transmitting electrical energy can be an electrical state that comprises at least one of the following parameters and/or is characterized by at least one of the following parameters: a conductivity and thus a (current) functional state of the contact element as a conductive or non-conductive contact element; a current transmitting capacity and thus a (maximum) electrical current intensity for essentially damage-free transmission; a fault status, for example as a result of a short circuit or an overtemperature.

The voltage state of the at least one contact element for transmitting electrical signals can, for example, comprise at least one current voltage value; a rest potential and/or a reference potential, in particular each relative to the intermediate circuit; a switching/transition voltage value; a voltage rise time duration and/or a voltage fall time duration. The voltage state of the at least one contact element for transmitting electrical signals (signal contact element) can thus be characterized not only by a static state, but also by a dynamic state.

The at least one storage element can, for example, be configured as a capacitor. The voltage state of the at least one storage element of the intermediate circuit can, for example, comprise at least one current voltage value; a rest/equilibrium voltage value; a time-dependent voltage curve during charging and/or discharging; a voltage rise time duration; a voltage fall time duration; and/or a current temperature value.

According to a further aspect of the present invention, it can be provided that the microprocessor module is configured, for and/or before discharging the intermediate circuit upon a determined interruption of the communication connection with the at least one supply device, in particular upon an identified disconnection of the at least one supply device, to determine a drive unit state of the drive unit and, depending on the determined drive unit state, to switch the switching module differently, wherein the drive unit state comprises at least one of the following: • a location of the rotor relative to the stator; • a motion state of the rotor; • a mechanical load state of the rotor; • a thermal load state of the stator; • at least one inductance of the drive unit before and/or after the switching operation of the at least one switching unit; • at least one resistor, in particular at least one winding resistor of at least one winding of the stator, of the drive unit before and/or after the switching operation of the at least one switching unit; • a current present in the drive unit, in particular in the stator (for example, phase current and/or winding current).

Determining the drive unit state can comprise a recording (measuring), a retrieving, and/or a calculating. The recordation (measurement) can be realized by means of at least one sensor unit. The retrieval can be realized by means of a stored, at least two-dimensional drive unit characteristic map. The calculation can be realized on a model-based basis, in particular based on a drive unit simulation model.

The microprocessor module can, for example, be configured to determine the location of the rotor relative to the stator and/or the motion state of the rotor by evaluating recorded magnetic fields. To this end, the microprocessor module can be connected to at least one sensor unit. The at least one sensor unit can, for example, be formed as a Hall sensor unit and configured to generate a sensor information based on a detected presence and/or a detected polarity of the magnetic field. The at least one sensor unit can be arranged at a defined location, that is, at a defined position and/or with a defined alignment on the stator.

The microprocessor module can additionally or alternatively be configured to determine the location of the rotor relative to the stator and/or the rotational state of the rotor by evaluating a recorded induced voltage in at least one winding of the stator.

The microprocessor module can be connected to a corresponding sensor unit in each case to determine the mechanical load state of the rotor and/or the thermal load state of the stator. The microprocessor module can be configured, additionally or alternatively, to determine the mechanical load state of the rotor and/or the thermal load state of the stator on a model-based and/or map-based basis.

The microprocessor module can be configured to switch the switching module at least partially in a current-dependent, speed-dependent, sensorless, map-based, and/or characteristic-based manner. The drive unit state can, in particular, be associated with the stator of the drive unit. The at least one inductance can be a phase inductance of a winding (also referred to as “winding inductance”) of the stator. The resistor can be a winding resistor of a winding of the stator. The phase inductance and/or the winding resistor can each be associated with a defined phase (electrically isolated current path) and thus to a defined winding.

The switching module can thus be switched accordingly by the microprocessor module depending on a respective state of the drive unit to cause a discharge of the intermediate circuit. The microprocessor module can be configured, depending on the drive unit state determined, to adapt the switching strategy of the switching module in such a way that a period of time for discharging (discharge duration) the intermediate circuit is reduced, in particular is minimized. Likewise, the switching strategy can be adapted to an expected heat generation.

It is possible that the microprocessor module is configured, depending on the determined location of the rotor relative to the stator and/or the determined motion state of the rotor, to switch the switching module using a defined switching strategy in such a way that a determined electrical voltage present in the intermediate circuit is applied to at least one defined current path of the stator, in order to essentially maintain the determined location of the rotor relative to the stator and/or the determined motion state, in particular for at least a defined period of time.

According to a further aspect of the present invention, it can be provided that the microprocessor module, for determining the location of the rotor relative to the stator, is connected to at least one sensor unit, which is configured to record at least one defined operating information and/or a change in at least one defined operating information selected from the following: a magnetic field, a light intensity. Alternatively or additionally, the microprocessor module, for determining the location of the rotor relative to the stator, can be configured, in a sensorless manner, to record, transform and evaluate at least one current of an associated defined current path of the stator and/or at least one voltage at an associated defined current path of the stator.

The recordation of the at least one voltage on an associated defined current path can be performed in a sensorless manner based on the switching strategy or, alternatively, by means of voltage dividers in the form of resistors. This does not involve a voltage and thus a potential difference between two points of the switching module. The microprocessor module can, in particular, be configured, for recording the at least one voltage on the associated defined current path, to switch the switching module to a deactivated state, at least during the duration of the voltage recordation. The deactivated state of the switching module represents, in particular, a state of the switching module in which all switching elements are open, that is, not switched.

The at least one voltage can be a voltage induced as a result of the motion state of the rotor MR.

According to a further aspect of the present invention, it can be provided that the microprocessor module is configured, for discharging the intermediate circuit, to switch the switching module at a time when a defined motion state of the rotor and/or a defined location of the rotor relative to the stator, in particular a standstill of the rotor and/or a standstill location of the rotor, is determined; and/or that the microprocessor module is configured, for discharging the intermediate circuit, to switch the switching module in such a way that all current paths of the stator are short-circuited, in particular for a defined period of time, in order to brake the rotor, in particular essentially to a standstill and/or to a standstill location.

The switching for short-circuiting all current paths serves, in particular, to generate an induced counter-voltage in the windings of the stator, which, in this state, forms a low-resistance, closed current circuit, since the resistance is defined primarily by the copper resistance of the windings themselves. This, in turn, results in a current flow in the windings of the stator, which generates a magnetic field. The generated magnetic field serves, with respect to the rotor, as a braking torque in order to brake the rotor, in particular essentially to a standstill, at which the rotor is characterized by a standstill location. In other words, the microprocessor module is configured, for discharging the intermediate circuit, to switch the switching module in such a way that a counter-current braking function is realized in order to brake the rotor.

In other words, this allows for an energy conversion in which a kinetic energy of the rotor (and, furthermore, of the load connected to it in the form of a coupled tool element) is converted into heat, which arises from ohmic losses in the windings of the stator due to the flowing current and the winding resistance.

According to a further aspect of the present invention, it can be provided that the microprocessor module is configured, for discharging the intermediate circuit, to switch the switching module using a defined switching strategy in such a way that a determined present electrical voltage of the intermediate circuit is applied to at least one defined current path of the stator in at least one of the following forms: • periodically, in particular pulse-width modulated (also abbreviated as “PWM”), in order to change a location of the rotor relative to the stator; • high-frequency periodic depending on an inertia of the rotor, in particular at least one natural frequency of the rotor and/or a damping of the rotor, in order to set the rotor in at least one unstable, in particular oscillating, vibrational state; • statically pulse-width modulated (PWM), in particular essentially constant with respect to the at least one defined current path, in order to align the rotor in a defined location relative to the stator; • essentially periodically without averaging, in particular high-frequency without averaging periodic, in order to essentially maintain a location of the rotor relative to the stator.

The determined present electrical voltage can be applied periodically, that is, repeatedly at defined time intervals and/or with defined periods of time and/or with defined amplitudes, in order to generate a rotating magnetic field in the drive unit, that is, in the stator, which draws or carries the rotor along and/or essentially maintains it in a defined location. Through the switching configuration of the microprocessor module, the determined present electrical voltage can, for example, be applied to the at least one defined current path in the form of an alternating voltage with a defined frequency (which conversely corresponds to a defined period duration) in order thereby to impress the current present in the intermediate circuit into the drive unit.

It is possible that the determined present electrical voltage is applied in such a way that a period of time of a voltage pulse (also referred to as “pulse width”, “duty factor”, or “duty cycle”) is varied in order to switch the intermediate circuit to an essentially current-free and/or essentially voltage-free state by means of an induced and/or resulting change of location of the rotor relative to the stator.

The microprocessor module can be configured to switch the switching module, at least in sections, with an essentially constant and/or varying switching frequency in order to generate respective voltage pulses and/or current pulses.

The voltage of the intermediate circuit can be applied to the defined at least one current path by the circuit in accordance with the defined switching strategy periodically, in particular by pulse width modulation, for example with a switching frequency in a range between approximately 10 kilohertz and approximately 20 kilohertz, for example at approximately 16 kilohertz.

In the case of a high-frequency periodic application of the electrical voltage present in the intermediate circuit, the rotor can, depending on and/or relative to an inertia of the rotor, be set into an unstable, i.e. oscillating (vibratory) state, which differs in particular from the so-called torque ripple, which depends on the rotational movement of the rotor.

The frequency of the voltage application can be, as a forcing frequency for electrical excitation, dependent on the mass inertia and thus on the resulting moment of inertia of the rotor, and can, for example, be greater than approximately 20 kilohertz. The frequency of the voltage application can be selected such that it lies outside at least one natural frequency of the rotor, in order in particular to avoid excitation of a mechanical resonance frequency. In particular, the frequency of the voltage application is configured such that, as a result, the rotor is no longer able to follow, or does not follow, the voltage variation and transitions into an oscillatory motion state. The state of the rotor can, in contrast to torque ripple, comprise a transverse oscillation. In other words, the rotor can be set into a trembling motion by a high-frequency periodic voltage application and thus by a correspondingly modulated voltage, taking into account the inertia of the rotor, whereby an unstable oscillatory state is established. It is understood that, in the context of the invention, the unstable oscillatory state does not comprise an increase of an oscillation amplitude as a result of a disturbance.

A statically pulse-width-modulated voltage application comprises, in particular, the application of an essentially consistent (constant) and thus unchanging voltage to at least one defined current path, in which a stationary magnetic field is formed that does not move around an axis of the rotor. In other words, the PWM voltage signals are such that an essentially constant direct current or an essentially constant average current flows through the at least one defined current path, thereby generating a magnetic field in the stator that does not rotate over time, or at least rotates only minimally, and remains essentially stationary in space. The rotor is drawn and/or aligned into a defined location, in particular a specific angular position, and essentially held there.

Applying the voltage present in the intermediate circuit in an essentially periodic manner without averaging, in particular in an essentially high-frequency manner without averaging, form to at least one defined current path leads to the generation of a magnetic field, which, for example, interacts with permanent magnets of the rotor without essentially generating an effective torque that causes a significant change in the location of the rotor. This serves, for example, for active stabilization and maintaining a current location, i.e. position, of the rotor relative to the stator. By means of a comparatively high-frequency voltage application and thus a high-frequency actuation, movements or deviations of the rotor from a location can be prevented or at least essentially minimized. By means of an essentially high-frequency actuation without averaging, it can be ensured in particular that essentially no permanent force component acts in the direction of rotation, whereby the location of the rotor relative to the stator can be kept essentially constant and thus maintained.

The frequency of the voltage application can additionally depend on a determined damping of the rotor. The damping of the rotor can, for example, be caused by at least one of the following: a friction of bearing elements of the rotor, an elastic deformation of the rotor, eddy currents within the rotor and/or the stator.

A duration of the discharge, that is, the discharge process of the intermediate circuit, can range from a few milliseconds to a maximum of a few seconds, depending on the state of charge of the intermediate circuit. The intermediate circuit can comprise at least one storage element, in particular in the form of an intermediate circuit capacitor, which is configured for the limited storage of electrical energy. It is understood that the at least one storage element can be configured primarily for smoothing a DC voltage and/or for short-term buffering of energy flows.

It is understood that the microprocessor module is configured to determine the inertia and/or damping of the rotor. The inertia of the rotor can include the inertia of a connected load in the form of a coupled tool element of the tool.

According to a further aspect of the present invention, it can be provided that the microprocessor module is configured, for discharging the intermediate circuit, to switch the switching module using a defined switching strategy in such a way that at least one of the following is generated at the drive unit, in particular for a defined period of time in each case: • an essentially constant torque; • a periodically inverting torque; • a maximum torque; • an essentially constant power; • a current flow essentially parallel to a direction of the magnetic flux of the rotor.

The microprocessor module is in particular configured to determine a location of the rotor using at least one sensor unit or in a sensorless manner.

A essentially constant torque, in particular for at least a defined period of time, can be achieved, in particular within the framework of a so-called field-oriented control (also abbreviated as “FOC”), by means of a pulse width modulation strategy. In other words, the voltage present in the intermediate circuit in the form of a DC voltage can be converted by means of the switching strategy of the microprocessor module for the switching module into a system of AC voltages of variable frequency and amplitude and applied to the at least one defined current path by means of corresponding switching operations. It is possible for a value of the torque to remain essentially constant for a defined period of time and/or to be maintained essentially constant.

A periodically inverting torque comprises, in particular, the modulation of a current flow in the windings of the stator and/or a magnetic flux direction in such a way that the resulting torque alternates, for example, in a sinusoidal, rectangular, or trapezoidal manner between a direction defined as positive direction and a direction defined as negative direction. In this context, a so-called transverse-axis current is reversed in polarity, in particular by the switching module, in order to invert the torque.

The generation of a maximum torque can be realized, for example, by applying the voltage present in the intermediate circuit to at least one defined current path in order to generate a magnetic field whose resulting and/or idealized vector is oriented essentially at 90 electrical degrees with respect to a resulting and/or idealized vector of the magnetic field of the rotor, wherein in particular an amount of the current in the stator is maximized. This can be implemented, for example, by means of the so-called field-oriented control method.

The generation of a current flow essentially parallel to a direction of the magnetic flux of the rotor can, for example, also be implemented using the field-oriented control method, which results in essentially no torque being generated. The rotor remains at a standstill location or is in a motion state due to its inertia.

According to a second general aspect, the present invention relates to a method for operating a tool, in particular a mobile and/or hand-held tool, wherein the tool comprises: • a drive unit with a stator and a rotor, which is configured to convert electrical energy to drive at least one tool element of the tool; • at least one contact element for transmitting electrical energy and/or electrical signals, which is configured to form a disconnectable terminal connection with at least one supply device for providing electrical energy and/or electrical signals, in order to be able to provide electrical energy and/or electrical signals to the drive unit in a connection state of the at least one supply device; • an intermediate circuit that electrically connects the drive unit to the at least one contact element, which comprises a switching module for the drive unit and a microprocessor module for controlling and/or regulating the switching module, wherein the method comprises:
determining an interruption, in particular an interruption process and/or an interruption state, of a communication connection with the at least one supply device by the microprocessor module;—switching at least one switching unit of a current-limiting and/or voltage-control module of the intermediate circuit, which is in particular arranged between at least one contact element for transmitting electrical energy and the switching module, in order to switch at least one contact element for transmitting electrical energy on the tool side to an essentially voltage-free state;
impressing a current present in the intermediate circuit into the drive unit in order to essentially discharge the intermediate circuit; wherein, in particular, the method is configured for execution on a tool as disclosed herein.

It is possible that the method comprises:—identifying a disconnection, in particular a disconnection process and/or a disconnection state, of at least one supply device by the microprocessor module based on at least one operating information; and
switching the at least one switching unit by the microprocessor module at least before the current present in the intermediate circuit is impressed into the drive unit.

### BRIEF DESCRIPTION OF THE DRAWINGS

Other objects and features of the present invention will become apparent from the following detailed description considered in connection with the accompanying drawings, which disclose at least one embodiment of the present invention. It should be understood, however, that the drawings are designed for the purpose of illustration only and not as a definition of the limits of the invention.

In the drawings, wherein similar reference characters denote similar elements throughout the several views:

The embodiments and features of the present invention described above can be combined with one another in any manner. Further or other details and advantageous effects of the present invention are explained in more detail below with reference to the accompanying figures.

It shows:

FIG. 1 a first embodiment of the tool according to the present invention in a schematic illustration;

FIG. 2 the drive unit of the tool from FIG. 1 in a schematic illustration;

FIG. 3 a first diagram illustrating the discharge of the intermediate circuit via the drive unit shown in FIGS. 1 and 2;

FIG. 4 a second diagram illustrating the discharge of the intermediate circuit via the drive unit shown in FIGS. 1 and 2; and

FIG. 5 a third diagram illustrating the discharge of the intermediate circuit via the drive unit shown in FIGS. 1 and 2.

### DETAILED DESCRIPTION

Identical or functionally equivalent components or elements are marked with the same reference signs in the figures. For the sake of clarity, reference is also made in part to the description of other embodiments and/or figures in order to avoid repetition.

The following detailed description of the embodiments shown in the figures serves to provide further illustration or clarification and is not intended to limit the scope of the present invention in any way.

In the following, in relation to device/s, element/s, unit/s, as well as signal/s, information/s and/or property/s, the expression “at least one” is omitted where appropriate for the sake of simplicity. It is understood that, for example, instead of one device/unit also several devices/units and/or instead of one signal/information/property also several signals/information/properties can be included or are included.

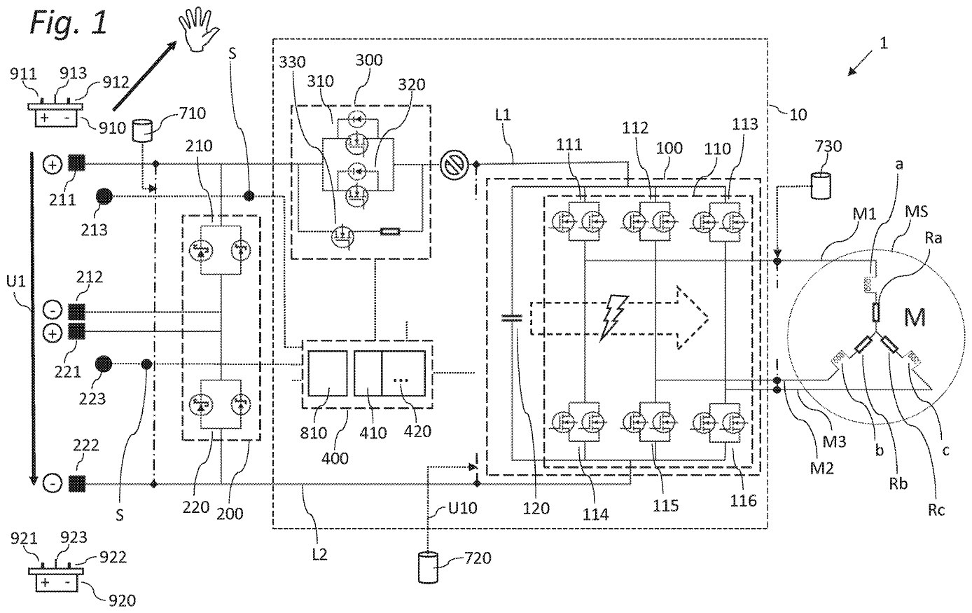

FIG. 1 shows a first embodiment of the tool 1 according to the present invention in a schematic illustration, that is, in the form of a so-called block diagram.

The tool 1 can be a mobile and/or hand-held and/or hand-guided electrical tool 1 (power tool, electrical device). The tool 1 can be a manually operable tool 1. The tool 1 can, for example, be formed as one of the following and/or comprise at least one of the following: a garden tool, for example in the form of a mower, a trimmer, a scarifier, a shear, a scythe, a blower; a forestry tool, for example in the form of a chainsaw; a cleaning tool, for example in the form of a high-pressure cleaner; an assembly tool, for example in the form of a drill, a percussion drill, a hammer, a cut-off grinder, a saw; an agricultural tool for working the soil, for example in the form of a mulcher; a carpentry tool, for example in the form of a planer; a kitchen/household tool, for example in the form of a mixer, a vacuum cleaner, a compressor. Further forms and configurations of the tool 1 are possible, for example for the medical technology sector.

The tool 1 according to the present invention is configured to form a disconnectable (detachable) connection with at least one supply device 910, 920. The disconnectable connection comprises, in particular, a disconnectable electrical connection (separable terminal connection) and/or a disconnectable mechanical connection (separable form-fit and/or force-fit connection).

The at least one supply device 910, 920 is, in a connection state, configured to provide electrical energy and/or electrical signals S to the tool 1. In particular, the connection state represents a state in which the at least one supply device 910, 920 is properly connected electrically and mechanically to the tool 1.

In the first embodiment shown in FIG. 1, the tool 1 is configured for disconnectable connection with two supply devices 910 and 920. Alternatively, it is possible that the tool 1 is configured for disconnectable connection with (only) one supply device 910, 920 or for disconnectable connection with more than two supply devices 910, 920.

Each supply device 910, 920 is formed in the form of a mobile, rechargeable accumulator 910 and 920 for providing a DC voltage as the supply voltage of the tool 1. The accumulator can comprise at least one lithium-ion cell or several lithium-ion cells connected in series and provide a nominal voltage of approximately 36 volts.

To form the disconnectable connection with the respective supply device 910, 920, the tool 1 comprises four contact elements 211, 212; 221, 222 in the form of load contact elements for transmitting electrical energy. The contact elements 211 and 212 form a first contact element pair 211, 212 and the contact elements 221, 222 form a second contact element pair 221, 222.

The supply device 910 comprises two contact elements 911 and 912 in the form of load contact elements for transmitting electrical energy, which are associated with the contact elements 211, 212 as mating contact elements 911, 912. The supply device 920 comprises two contact elements 921 and 922 in the form of load contact elements for transmitting electrical energy, which are associated with the contact elements 221, 222 as mating contact elements 921, 922.

The contact elements 211 and 221 can each be associated with the positive pole and the contact elements 212 and 222 can each be associated with the negative pole. By correspondingly arranging and electrically connecting the contact elements 211, 212; 221, 222 in the form of a series connection, for example, an increased overall voltage can be provided as the supply voltage for the tool 1. The supply voltage can thus be approximately 72 volts by the two series-connected supply devices 910 and 920 and can be provided to the tool 1 in the connection state. In other words, the tool 1 is characterized by a high-performance battery system with a nominal voltage of approximately 72 volts.

In another embodiment of tool 1, it is possible that the supply devices 910, 920 are combined as a single accumulator with at least one cell module, in particular with a plurality of cell modules, and comprise two, in particular exactly two, load contact elements 911, 912 for transmitting electrical energy.

For communication with the respective supply device 910, 920 in the connection state, the tool 1 each comprises at least one contact element 213, 223 in the form of a signal contact element for transmitting electrical signals between the respective supply device 910, 920 and the tool 1. To establish a communication connection S via signals, the supply device 910 comprises the signal contact element 913, and the supply device 920 comprises the signal contact element 923. The signal contact element 913 is associated with the signal contact element 213, and the signal contact element 923 associated with the signal contact element 223.

The tool 1 comprises a communication unit 810 with a signal transmission/reception module and/or a communication interface module. The signal transmission/reception module and the communication interface module are not shown in detail and/or labeled in the figures for the sake of clarity.

The communication unit 810 can be part of a microprocessor module 400 as the central module of the tool 1 for controlling and/or regulating modules 110, 300; units 111, 112, 113, 114, 115, 116, 310, 320, 330, 410, 420, 710, 720, 730, 751, 752, 753, and/or elements 120 of tool 1.

The microprocessor module 400 comprises a computing unit 410 (microprocessor, CPU) and further units such as, for example, an interface unit 420, a memory unit (RAM, Flash), etc. The microprocessor module 400 is thus configured to form a communication connection S via signals with the supply devices 910, 920.

The tool 1 is further configured to form the disconnectable mechanical connection in the form of a plug-in connection or in the form of a plug-in snap-in connection with a respective supply device 910, 920. In particular, the disconnectable mechanical connection can be disconnected manually, so that no tool is required, for example, for mounting and removing the supply devices 910 and 920 on the tool 1. This ensures that the tool 1 is easy to handle.

However, a manually and thus tool-free disconnectable connection in the form of a disconnectable plug-in connection or a disconnectable plug-in snap-in connection can make it possible to disconnect the respective supply devices 910, 920 from the tool 1, whereby, in particular, the contact elements 211, 212; 221, 222 are then freely accessible. It is possible that a voltage U1 of more than approximately 60 volts is present at the contact elements 211, 212; 221, 222 after a disconnection process.

It is optionally possible for the tool 1 to comprise a protection module 200 for the supply devices 910 and 920, which is electrically connected to the contact elements 211, 212; 221, 222 accordingly. The protection module 200 comprises a first protection unit 210 and a second protection unit 220. The first protection unit 210 and the second protection unit 220 are connected in series with one another between the contact elements 211 and 222. The first protection unit 210 is in turn arranged between and/or associated with the contact elements 211 and 212, and the second protection unit 220 is in turn arranged between and/or associated with the contact elements 221 and 222. Both the first protection unit 210 and the second protection unit 220 each comprise two protection elements connected in parallel with one another in the form of a suppressor diode (transient voltage suppressor diode) and in the form of a Schottky diode (hot-carrier diode) and each serves, in particular, as an overvoltage protection unit, particularly in the case of brief voltage pulses, and/or as a reverse current protection unit for the respectively associated supply device 910, 920 in the connection state.

It is understood that in order to form a plug-in connection or a plug-in snap-in connection, both the tool 1 and the supply devices 910, 920 each have mutually complementary plug-in sections and thus mutually complementary plug-in faces in order to realize the respective disconnectable, essentially form-fit and/or essentially force-fit, connection in a plug-in direction.

In other words, the tool 1 in FIG. 1 is a battery-operated tool 1 for connecting and/or comprising two supply devices 910 and 920 in the form of replaceable and/or rechargeable accumulators 910 and 920. Alternatively, it is possible that the at least one supply device 910, 920 is formed as a plug connector, for example in the form of a plug, and/or comprises at least one such plug connector, wherein the plug connector is in turn connected to a cable for providing electrical energy and/or electrical signals, and wherein the plug connector is configured to form a manually disconnectable mechanical connection in the form of a plug-in connection or in the form of a plug-in snap-in connection with the tool 1.

The tool 1 comprises a drive unit M, which is configured to convert electrical energy in order to drive at least one tool element of the tool 1, in particular in an operating state. For reasons of clarity, the at least one tool element is not shown in the figures and can, depending on the form and/or configuration of the tool 1, comprise, for example, a cutting unit with cutting blades, a cutting disk, a pump, etc. A gearbox for converting the rotational speed and/or torque can be arranged between the drive unit M and the at least one tool element.

The tool 1 comprises an intermediate circuit 10 (also referred to in abbreviated form as “DC link”), which electrically connects the drive unit M to the contact elements 211, 212; 221, 222, that is, to the contact elements 211 and 222 resulting from the interconnection.

In the connection state of the supply devices 910 and 920, electrical energy can be provided to the drive unit M via the intermediate circuit 10 in order to operate the tool 1.

The intermediate circuit 10 comprises a first main line L1 and a second main line L2 for transmitting electrical energy. The first main line L1 is electrically connected to the contact element 211 and the second main line L2 is electrically connected to the contact element 222. In other words, the main lines L1 and L2 represent electrical power paths of the tool 1.

To operate the drive unit M, the intermediate circuit 10 comprises a drive unit circuit 100 with a switching module 110 and at least one storage element 120. The switching module 110 is an electronic switching module 110 and is used to supply the drive unit M with electrical energy and to commutate the drive unit M. The microprocessor module 400 is used for controlling and/or regulating the switching module 110.

The switching module 110 comprises six switching units 111, 112, 113, 114, 115, 115, 116 with switching elements, which are not shown in detail in the figures for the sake of clarity.

Each switching unit 111, 112, 113, 114, 115, 116 is formed in particular as a semiconductor switching unit with each two switching elements in parallel connection. Alternatively, it is possible that the respective semiconductor switching unit 111, 112, 113, 114, 115, 116 comprises only one (single) switching element in each case. In particular, each switching element is formed as an electronic switching element based on a semiconductor (semiconductor switching element). The respective switching element of the switching units 111, 112, 113, 114, 115, 116 can be configured as one of the following: a metal-oxide semiconductor field-effect transistor (abbreviated as “MOSFET”), a bipolar transistor with an insulated gate electrode (abbreviated as “IGBT”), or a high-electron-mobility transistor (abbreviated as “HEMT”). In other words, the switching units 111, 112, 113, 114, 115, 116 represent bridge transistors and form a so-called six-pulse half-bridge circuit.

The switching elements of the switching units 111, 112, 113, 114, 115, 116 can each be connected in parallel with a rectifier element in the form of a diode, in order to realize a rectification of the current flow in a non-switched state of the switching module 110 and/or in an uncontrolled manner.

The switching units 111 and 114 are electrically connected to the phase line M1 of the drive unit M, the switching units 112 and 115 to the phase line M2 of the drive unit M, and the switching units 113 and 116 to the phase line M3 of the drive unit M.

By controlling and/or regulating the switching module 110 via the microprocessor module 400, the DC voltage provided by the supply devices 910 and 920 is converted into a suitable three-phase current for operating the electric motor M.

The at least one storage element 120 can be formed as a capacitor and/or comprise a capacitor, for example in the form of an electrolytic capacitor as a passive electronic component. In other words, the at least one storage element 120 can be an intermediate circuit capacitor.

The at least one storage element 120 can be formed and/or configured to smooth out voltage fluctuations in the DC voltage provided by the supply devices 910 and 920 as supply voltage, in particular with respect to voltage peaks and voltage dips. As a result, for example, a substantially stable DC voltage can be provided and supplied to the switching module 110. The at least one storage element 120 can additionally or alternatively be configured for filtering high-frequency interferences in the DC voltage as the supply voltage. Additionally or alternatively, the at least one storage element 120 can also serve as an energy storage device in the event of short-term failures of the DC voltage as supply voltage and provide electrical energy to the switching module 110.

A current limiting and/or voltage control module 300 is arranged and/or connected between the drive unit circuit 100 and the contact element 211. In the first embodiment of the tool 1 shown in FIG. 1, the current limiting and/or voltage control module 300 is arranged on the first main line L1 and comprises at least a first switching unit 310, a second switching unit 320, and a third switching unit 330. The first switching unit 310 and the second switching unit 320 are connected in parallel with each other. The switching units 310 and 320, which are connected in parallel with one another, are in turn connected in parallel with the third switching unit 330. Each switching unit 310, 320, 330 comprises a switching element in the form of a semiconductor switching element, for example a metal-oxide semiconductor field-effect transistor, a bipolar transistor with an insulated gate electrode, or a high-electron-mobility transistor.

The switching elements of switching units 310 and 320 are each connected in parallel with a rectifier element in the form of a diode. The switching element of the third switching unit 330 is connected in series with a resistor element. The current-limiting and/or voltage-control module 300 is controlled and/or regulated by the microprocessor module 400.

The microprocessor module 400 is configured to determine an interruption, in particular an interruption process and/or an interruption state, of the communication connection S with the at least one supply device 910, 920, and, upon determining an interruption, to switch at least one switching unit 310, 320 of the current limiting and/or voltage control module 300 of the intermediate circuit 10, in order to switch at least the contact element 211 for transmitting electrical energy on the tool side to an essentially voltage-free state, and to impress a current present in the intermediate circuit 10 in the form of stored electrical energy into the drive unit M for discharging the intermediate circuit 10.

By means of the microprocessor module 400, a determination of an interruption of the communication connection S with the at least one supply device 910, 920 can be carried out as disclosed herein, wherein, in the event of a determined interruption, at least one switching unit 310, 320 of the current-limiting and/or voltage-control module 300 is switched in order to switch the contact element 211 to an essentially voltage-free state.

The microprocessor module 400 is thus configured to monitor the communication connection S with the at least one supply device 910, 920 as disclosed herein. For example, the microprocessor module 400 can be configured to initiate and/or execute a so-called handshake protocol with the at least one supply device 910, 920, wherein a diagnostic communication signal and/or a readiness communication signal is sent to the at least one supply device 910, 920 and a corresponding response signal is received. Additionally or alternatively, the microprocessor module 400 can be configured to execute a timer function and/or a timeout function, which monitors a reception of an expected communication signal of the at least one supply device 910, 920 within a defined period of time. It is further additionally or alternatively possible that the microprocessor module 400 is configured to compare defined communication parameters of received communication signals with defined communication reference parameters in order to identify an abnormal communication state in the event of a defined deviation. Furthermore, the microprocessor module 400 can additionally or alternatively be configured to monitor multiple communication channels with the at least one supply device 910, 920 essentially simultaneously, wherein a discrepancy between communication signals of different channels is used to identify an abnormal communication state. The abnormal communication state can represent an interruption of the communication connection S.

The tool 1 according to the present invention is characterized, for example, in that, already upon a communication connection S between the microprocessor module 400 and the at least one supply device 910, 920 no longer being intact, at least one switching unit 310, 320 of the current-limiting and/or voltage-control module 300 is switched such that the load contact element 211 is switched on the tool side to an essentially voltage-free state and, in particular subsequently in time, electrical energy stored in the intermediate circuit 10 and thus a current present in the intermediate circuit 10 is impressed into the drive unit M.

The at least one supply device 910, 920 is electrically disconnected from the tool 1 by the switching operation of the at least one switching unit 310, 320, so that no electrical energy can be supplied to the tool 1 anymore. The at least one supply device 910, 920 can continue to form a mechanical connection with the tool 1, meaning that there is not yet a disconnection from the tool 1. An interruption of the communication connection S is accompanied by a (mechanical) disconnection of the at least one supply device 910, 920 from the tool 1 (for example, by manually removing the at least one supply device 921, 920).

The microprocessor module 400 is, in particular, additionally configured, upon a determined interruption of the communication connection, depending on at least one defined operating information to identify a disconnection, in particular a disconnection process and/or a disconnection state, of the at least one supply device 910, 920 and to switch the at least one switching unit 310, 320 at least before the impressing of the current present in the intermediate circuit 10 into the drive unit M.

This ensures that, in any case, the contact element 211 as a load contact element is initially switched to an essentially voltage-free state on the tool side.

The at least one defined operating information can be configured and/or formed as disclosed herein. The at least one defined operating information can, for example, comprise a current transmission state of the contact element 211 during and/or after the determination of the interruption of the communication connection S with the at least one supply device 910, 920; a voltage state of the contact element 213 for transmitting electrical signals and/or a voltage state of the contact element 211 for transmitting electrical energy, in each case during and/or after the determination of the interruption of the communication connection S with the at least one supply device 910, 920; and/or a voltage state of the at least one storage element 120.

The energy stored in the intermediate circuit 10 is determined, among other things, significantly by the state of the at least one storage element 120. In other words, the state of the intermediate circuit capacitor 120 in particular ensures a voltage U10 present in the intermediate circuit 10 and the current present in the intermediate circuit 10 for impressing into the drive unit M.

It is understood that the tool 1 can comprise further units, modules, and/or elements that are not described in detail, for example the sensor units 710, 720 connected to the microprocessor module 400 for recording (measuring) a respective applied voltage U1, U10.

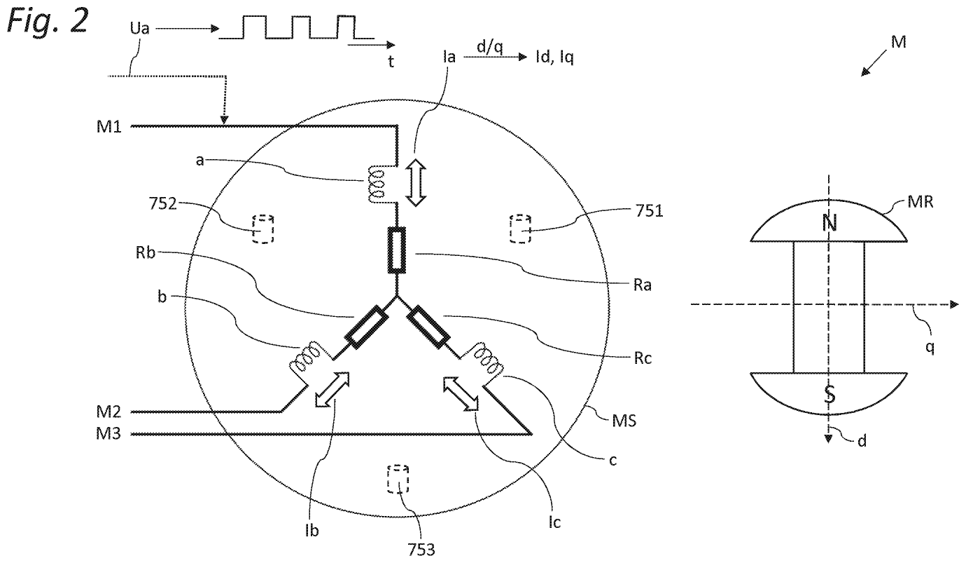

FIG. 2 shows a schematic illustration of the drive unit M of the tool 1 from FIG. 1 for further illustration.

The drive unit M is, in particular, a rotating-field machine in the form of a brushless three-phase motor M, which is characterized by a so-called star connection. The drive unit M comprises a stator MS as the stationary part and a rotor MR as the rotating part. The rotor MR is, in particular, equipped with permanent magnets (permanently excited rotor).

The stator MS of the drive unit M is equipped with three separate electromagnets, i.e. windings a, b, c. One respective end of the three windings a, b, c is electrically connected to a common point (also referred to as a “star point” or “neutral point”). The respective other end of the three windings a, b, c, which is not connected to the star point, is connected to a respective one of the three phase lines M1, M2, M3.

Due to technological reasons, respective resistances Ra, Rb, Rc are inherent to the three windings a, b, c, which resistances are also referred to as “winding resistances” or “copper resistances”. The resistances Ra, Rb, Rc are illustrated in FIG. 2 in a symbolically emphasized manner for the purpose of clarification and result from the electrical resistance of the respective electrical conductors forming the windings a, b, c.

Such resistors Ra, Rb, Rc are parasitic, as they do not (directly) contribute to the functionality of the drive unit M, but merely cause losses, for example in the form of heat.

The drive unit M is thus characterized by a three-phase winding having three phase branches, in order to generate, by means of appropriate control and/or regulation, a traveling (rotating) magnetic field, i.e. a rotating magnetic field, so as to entrain the rotor MR and thereby set it into a rotational motion. The rotor MR is in turn coupled to the at least one tool element of the tool 1, for example directly (immediately) or via a transmission. As already described, the at least one tool element and further components of the tool 1 are omitted for reasons of clarity.

The drive unit M can be configured as a known electric motor M, in particular as a known brushless three-phase motor M.

The microprocessor module 400 is configured, for and/or before discharging the intermediate circuit 10 upon determining an interruption of the communication connection S with the at least one supply device 910, 920, in particular upon an identified disconnection of the at least one supply device 910, 920, to determine at least one drive unit state of the drive unit M, for example by means of at least one (generated) sensor information of at least one sensor unit 751, 752, 753 and/or sensorless.

Additionally, the microprocessor module 400 is configured, depending on the determined drive unit state, to switch the switching module 110 differently, in particular to switch it in a manner adapted to the determined at least one drive unit state, in order, for example, to optimize, in particular to minimize, a period of time of the discharge of the intermediate circuit 10 and/or a thermal behavior of the drive unit M.

The drive unit state can comprise at least one of the following: a location of the rotor MR relative to the stator MS, in particular a position and/or alignment of the rotor MR relative to the stator MS; a motion state of the rotor MR, in particular relative to the stator MS; a mechanical load state of the rotor MR, in particular in connection with a load coupled to the rotor MR in the form of a tool element; a thermal load state of the stator MS, in particular a temperature of the stator MS; at least one inductance of the drive unit M before and/or after the switching operation of the at least one switching unit 310, 320; at least one resistor Ra, Rb, Rc of the drive unit M, in particular of the stator MS, before and/or after the switching operation of the at least one switching unit 310, 320; at least one current Ia, Ib, Ic present in the drive unit M, in particular in the stator MS.

Due to the configuration of the drive unit M in the form of a star connection, the currents Ia, Ib, Ic represent currents in the phase lines (phase currents) M1, M2, M3 and simultaneously currents in the windings (winding currents) a, b, c of the stator MS.

For sensor-based determination of the drive unit state, the sensor units 751, 752, 753 are shown schematically in FIG. 2. The sensor units 751, 752, 753 can be arranged on the drive unit M, comprised by the drive unit M, and/or integrated into the drive unit M. The sensor units 751, 752, 753 can, for example, comprise at least one temperature sensor element, one torque sensor element, and/or one Hall sensor element.

The microprocessor module 400 can, for determining the location of the rotor MR relative to the stator MS, be connected to at least one of the sensor units 751, 752, 753 of the drive unit M. It is alternatively or additionally possible, that the microprocessor module 400 can, for determining the location of the rotor MR relative to the stator MS, be configured, in a sensorless manner, to record, transform and evaluate at least one current Ia, Ib, Ic (here phase current and simultaneously winding current) of an associated defined current path M1, a; M2, b; M3, c of the stator MS and/or, in a sensorless manner, to record, transform and evaluate at least one voltage Ua at the associated defined current path M1, a; M2, b; M3, c of the stator MS.

It is also possible to record (measure) the at least one current Ia, Ib, Ic and/or the at least one voltage Ua, for example, by means of the sensor unit 730 (see FIG. 1). The sensor unit 730 can comprise a current sensor element and/or a voltage sensor element for this purpose.

It is understood that the at least one current Ia, Ib, Ic and the at least one voltage Ua result in particular from a motion state of the rotor MR relative to the stator MS, and that, due to the switching operation of the at least one switching unit 310, 320, no electrical energy is directly provided to the drive unit M from the at least one supply device 910, 920, since the latter is electrically disconnected from the intermediate circuit 10 by the switching operation of the at least one switching unit 310, 320.

For discharging the intermediate circuit 10, the microprocessor module 400 can be configured to switch the switching module 110 at a time, in particular only when a defined motion state of the rotor MR and/or a defined location of the rotor MR relative to the stator MS, in particular a standstill of the rotor MR and/or a standstill location of the rotor MR, is determined.

Additionally or alternatively, it is possible that the microprocessor module 400 is configured, for discharging the intermediate circuit 10, to switch the switching module 110 in such a way that all current paths M1, a; M2, b; M3, c of the stator MS are short-circuited, in particular for a defined period of time, in order to brake the rotor MR, in particular to a standstill of the rotor MR and/or to a standstill location of the rotor MR.

For discharging the intermediate circuit 10, the microprocessor module 400 can be configured, in particular with, upon, and/or after a reaching of a standstill and/or a standstill location of the rotor MR, to switch the switching module 110 using a defined switching strategy in such a way that the determined present electrical voltage U10 of the intermediate circuit 10 is applied, as a voltage Ua, to at least one defined current path M1, a; M2, b; M3, c of the stator MS in at least one of the following forms: • periodically, in particular pulse-width modulated (also abbreviated as “PWM”), in order to change a location of the rotor MR and thus a position and/or alignment relative to the stator MS; • high-frequency periodic depending on an inertia of the rotor MR, in particular at least one natural frequency of the rotor MR, in order to set the rotor MR in at least one unstable, in particular oscillating, vibrational state; • statically pulse-width-modulated (PWM), in particular essentially constant with respect to the at least one defined current path M1, a; M2, b; M3, c, in order to align the rotor MR in a defined location relative to the stator MS; • essentially periodically without averaging, in particular high-frequency without averaging periodic, in order to essentially maintain a location of the rotor MR relative to the stator MS.

The microprocessor module 400 can be configured, for discharging the intermediate circuit 10, to switch the switching module 110 using a defined switching strategy in such a way that at the drive unit M at least one of the following is generated, in particular in each case for a defined period of time: • a essentially constant torque; • a periodically inverting torque; • a maximum torque; • an essentially constant power; • a current flow parallel to a direction of the magnetic flux of the rotor MR, whereby essentially no torque is generated for driving the rotor MR.

For illustrating the switching strategy, in FIG. 2, with respect to the winding a, which is connected and/or associated with the phase line M1, a voltage Ua at least partially resulting from the voltage U10, and thus a voltage component of the voltage U10, is symbolically shown in the form of a temporal profile. A portion of the voltage U10 which is applied to the phase line M1 and thus to the winding a is exemplarily shown in the form of a pulse-width-modulated profile over time t in order to highlight switching-on and switching-off times during the discharging process of the intermediate circuit 10.

The voltage Ua is applied, by means of the switching module 110, to the phase line M1 and thus to the winding a as a result of a control and/or regulation of the switching module 110 by the microprocessor module 400, whereby a feeding of the voltage U10 of the intermediate circuit 10 and an impressing of the current of the intermediate circuit 10 into the drive unit M, that is, into the winding a, takes place. In other words, applying the voltage Ua results in a current flow of the current Ia through the winding a. The current flow of the current Ia through the winding a can, for example, in turn generate a magnetic field which interacts with the magnetic field of the rotor MR, wherein a force is generated which, for example, rotates the rotor MR and/or maintains it essentially in a location.

It is understood that the current Ia depends not only on the voltage Ua, but also on other operating parameters, such as an inductance of winding a, a capacitance of winding a, a resistance Ra of winding a. The same applies to the other windings b and c.

The current Ia is a so-called phase-related winding current (also referred to as “armature current” or “stator current”). The current Ia can vary over time and/or depending on the movement and/or location of the rotor MR. For efficient voltage application and current impression, the phases M1, a; M2, b; M3, c, and thus the windings a, b, c, must be supplied with current at the respective time, which can be realized in particular by means of a so-called field-oriented control (abbreviated as “FOC”).

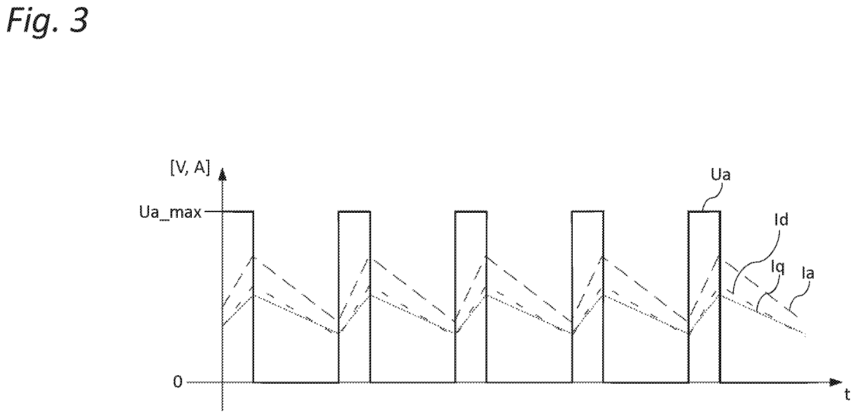

For explanation of the further FIGS. 3 through 5, which represent different voltage application strategies and current impression strategies, the current Ia (and correspondingly the other currents Ib and Ic through the windings b and c) can be converted (transformed) into current components of a rotating coordinate system that rotates synchronously with the rotor MR (see also the symbolic illustration in FIG. 2 of the transformation of the current Ia into the currents Iq and Id, indicated by an arrow).

The current Iq represents the so-called quadrature current. The quadrature current Iq is the component of the stator current that flows perpendicular to the magnetic flux of the rotor MR and thus along the quadrature axis (q-axis) in the rotor-fixed d-q coordinate system (see also FIG. 2). The quadrature current Iq is responsible for generating the electromagnetic torque that drives the rotor MR.

The current Id represents the so-called direct current. The direct current Id is the component of the stator current that flows parallel to the magnetic flux of the rotor MR and thus along the magnetic flux axis (d-axis) in the rotor-fixed d-q coordinate system (see FIG. 2 for further details). The direct current Id is responsible for generating the magnetic flux that influences the field strength in the air gap and thereby regulates and/or controls the attraction or repulsion between the stator MS and the rotor MR.

FIG. 3 shows a first diagram illustrating the discharge of the intermediate circuit 10 via the drive unit M from FIGS. 1 and 2, which represents a first example of a defined switching strategy for discharging the intermediate circuit 10.

The microprocessor module 400 is configured to control and/or regulate the switching module 110 in such a way that the voltage U10 of the intermediate circuit 10 is periodically, that is, in the form of a pulse-width-modulated signal, is applied as voltage Ua to the phase line M1 and thus to the winding a (see the rectangular (voltage signal) profile of voltage Ua with on and off times between 0 volts and Ua_max over time t). A current flow, i.e., a current Ia, is established, which can be represented by the currents Id and Iq.

The quadrature current Iq leads to the generation of a torque, which causes the rotor MR to move and, for example, align itself in a defined location and thus change location.

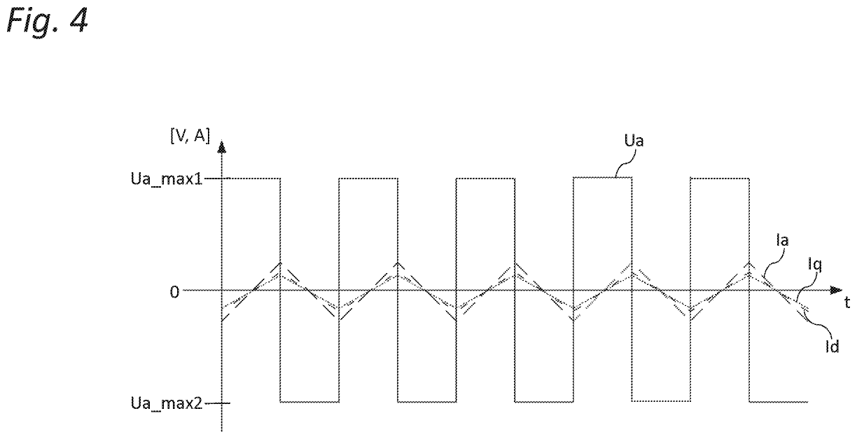

FIG. 4 shows a second diagram illustrating the discharge of the intermediate circuit 10 via the drive unit M from FIGS. 1 and 2, which represents a second example of a defined switching strategy for discharging the intermediate circuit 10.

The microprocessor module 400 is configured to control and/or regulate the switching module 110 such that the voltage U10 of the intermediate circuit 10 is applied to the phase line M1 and thus to the winding a as a voltage Ua in an essentially periodic manner without averaging, and, in particular, at a comparatively high frequency (for example equal to or greater than 1 kilohertz) (see the rectangular (voltage signal) profile between the voltage values Ua_max1 and Ua_max2 between 0 volts and Ua_max1/Ua_max2 over time t and without switching-on and switching-off times).

The resulting current flow Ia and thus the quadrature current Iq resulting therefrom or derived therefrom by transformation defines merely a high-frequency torque ripple (also referred to as “torque oscillation”). In this context, fluctuations in the generated torque occur periodically, whereby a location of the rotor MR changes only insignificantly and this location can thus be maintained essentially.

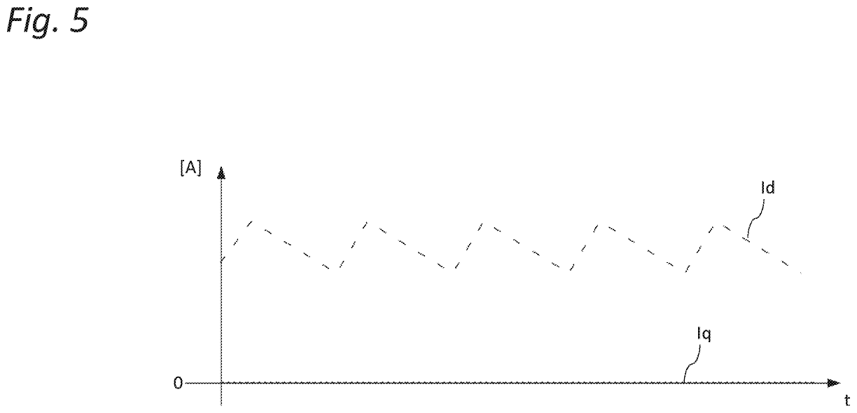

FIG. 5 shows a third diagram illustrating the discharge of the intermediate circuit 10 via the drive unit M from FIGS. 1 and 2, which represents a third example of a defined switching strategy for discharging the intermediate circuit 10.

The microprocessor module 400 can be configured to determine a location of the rotor MR relative to the stator MS by means of at least one sensor unit 751, 752, 753 or sensorless. In other words, the microprocessor module 400 can be configured, in the context of field-oriented control and/or regulation, to determine, in particular to calculate, the d-axis, which represents the direction of the magnetic flux generated by the permanent magnets of the rotor MR.

The microprocessor module 400 can be configured, depending on the determined location of the rotor MR, to apply the voltage U10 to at least one defined current path M1, a; M2, b; M3, c such that a current flows only or exclusively along the d-axis and not along the q-axis (see the profile of the current Iq at 0 amperes over time t), whereby essentially no torque is generated and, accordingly, the rotor MR is not entrained or driven.

From the discharge strategies illustrated in FIGS. 3 to 5, it becomes apparent that a voltage U10 present in the intermediate circuit 10 and/or a current present in the intermediate circuit 10 can be fed to and/or impressed into the drive unit M in different ways. The description relating to the voltage Ua and the current Ia applies correspondingly to the phase lines/windings M2, b; M3, c.

The present invention is not limited to the embodiments described above. Rather, a large number of variants and modifications are possible which also make use of the inventive concept and therefore fall within the scope of protection. In particular, the present invention also claims protection for the subject matter and features of the subclaims independently of the referenced claims.

Accordingly, while at least one embodiment of the present invention have been shown and described, it is to be understood that many changes and modifications may be made thereunto without departing from the spirit and scope of the invention as defined in the appended claims.

### LIST OF REFERENCE SYMBOLS

1 tool
10 intermediate circuit
100 drive unit circuit
110 switching module
111 switching unit
112 switching unit
113 switching unit
114 switching unit
115 switching unit
116 switching unit
120 storage element
200 protection module
210 protection unit
220 protection unit
211 load contact element
212 load contact element
213 signal contact element
221 load contact element
222 load contact element
223 signal contact element
300 current limiting and/or voltage control module
310 switching unit
320 switching unit
330 switching unit
400 microprocessor module
410 Computing unit
420 interface unit, memory unit (RAM, Flash), etc.
710 sensor unit
720 sensor unit
730 sensor unit
751 sensor unit
752 sensor unit
753 sensor unit
810 communication unit
910 supply device
911 load contact element
912 load contact element
913 signal contact element
920 supply device
921 load contact element
922 load contact element
923 signal contact element
a winding
b winding
c winding
Ia phase current, winding current
Ib phase current, winding current
Ic phase current, winding current
Id current for generating a magnetic field
Iq current for generating torque
L1 main line
L2 main line
M drive unit
M1 phase line
M2 phase line
M3 phase line
MR rotor
MS stator
Ra resistor
Rb resistor
Rc resistor
S communication connection
U1 voltage
U10 voltage
Ua voltage
Ua_max maximum voltage value
Ua_max1 maximum voltage value
Ua_max2 maximum voltage value
t time

1. A tool, comprising:
a drive unit with a stator and a rotor, which is configured to convert electrical energy to drive at least one tool element of the tool;
at least one contact element for transmitting electrical energy and/or electrical signals, which is configured to form a disconnectable terminal connection with at least one supply device for providing electrical energy and/or electrical signals,
in order to be able to provide electrical energy and/or electrical signals to the drive unit in a connection state of the at least one supply device;
an intermediate circuit that electrically connects the drive unit to the at least one contact element, which comprises a switching module for the drive unit and a microprocessor module for controlling and/or regulating the switching module,
wherein the microprocessor module is configured to determine an interruption of a communication connection with the at least one supply device and, upon a determined interruption, to switch at least one switching unit of a current-limiting and/or voltage-control module of the intermediate circuit,
in order to switch at least one contact element for transmitting electrical energy on the tool side to a voltage-free state and to impress a current present in the intermediate circuit into the drive unit for discharging the intermediate circuit.

2. The tool according to claim 1, wherein the current-limiting and/or voltage-control module is arranged between at least one contact element for transmitting electrical energy and the switching module.

3. The tool according to claim 1, wherein the microprocessor module is configured, upon a determined interruption of the communication connection depending on at least one defined operating information, to identify a disconnection of the at least one supply device, and to switch the at least one switching unit at least before the impressing of the current present in the intermediate circuit into the drive unit.

4. The tool according to claim 3, wherein the at least one defined operating information comprises at least one of the following:
a current transmission state of the at least one contact element for transmitting electrical energy during and/or after the determination of the interruption of the communication connection with the at least one supply device;
a voltage state of the at least one contact element for transmitting electrical energy and/or electrical signals during and/or after the determination of the interruption of the communication connection with the at least one supply device;
a voltage state of at least one storage element of the intermediate circuit, which is configured to realize at least one of the following functions: storing electrical energy; smoothing a voltage fluctuation; filtering a voltage disturbance.

5. The tool according to claim 1, wherein the microprocessor module is configured, for discharging the intermediate circuit upon a determined interruption of the communication connection with the at least one supply device, to determine a drive unit state of the drive unit and, depending on the determined drive unit state, to switch the switching module differently, wherein the drive unit state comprises at least one of the following:
a location of the rotor relative to the stator;
a motion state of the rotor;
a mechanical load state of the rotor;
a thermal load state of the stator;
at least one inductance of the drive unit before and/or after the switching operation of the at least one switching unit;
at least one resistor of the drive unit before and/or after the switching operation of the at least one switching unit;
a current present in the drive unit.

6. The tool according to claim 5, wherein the microprocessor module is configured, depending on the determined location of the rotor relative to the stator, to switch the switching module using a defined switching strategy in such a way that a determined electrical voltage present in the intermediate circuit is applied to at least one defined current path of the stator, in order to maintain the determined location of the rotor relative to the stator.

7. The tool according to claim 5, wherein the microprocessor module, for determining the location of the rotor relative to the stator, is connected to at least one sensor unit, which is configured to record at least one defined operating information and/or a change in at least one defined operating information selected from the following: a magnetic field, a light intensity; or
wherein the microprocessor module, for determining the location of the rotor relative to the stator, is configured, in a sensorless manner, to record, transform and evaluate at least one current of an associated defined current path of the stator and/or at least one voltage at an associated defined current path of the stator.

8. The tool according to claim 1, wherein the microprocessor module is configured, for discharging the intermediate circuit, to switch the switching module at a time at which a defined motion state of the rotor and/or a defined location of the rotor relative to the stator is determined; and/or
wherein the microprocessor module is configured, for discharging the intermediate circuit, to switch the switching module in such a way that all current paths of the stator are short-circuited in order to brake the rotor.

9. The tool according to claim 1, wherein the microprocessor module is configured, for discharging the intermediate circuit, to switch the switching module using a defined switching strategy in such a way that a determined present electrical voltage of the intermediate circuit is applied to at least one defined current path of the stator in at least one of the following forms:
periodically in order to change a location of the rotor relative to the stator;
high-frequency periodic depending on an inertia of the rotor in order to set the rotor in at least one unstable vibrational state;
statically pulse-width-modulated in order to align the rotor in a defined location relative to the stator;
periodically without averaging in order to maintain a location of the rotor relative to the stator.

10. The tool according to claim 1, wherein the microprocessor module is configured, for discharging the intermediate circuit, to switch the switching module using a defined switching strategy in such a way that at least one of the following is generated at the drive unit:
a constant torque;
a periodically inverting torque;
a maximum torque;
a constant power;
a current flow parallel to a direction of the magnetic flux of the rotor.

11. A method for operating a tool, wherein the tool comprises:
a drive unit with a stator and a rotor, which is configured to convert electrical energy to drive at least one tool element of the tool;
at least one contact element for transmitting electrical energy and/or electrical signals, which is configured to form a disconnectable terminal connection with at least one supply device for providing electrical energy and/or electrical signals,
in order to be able to provide electrical energy and/or electrical signals to the drive unit in a connection state of the at least one supply device;
an intermediate circuit that electrically connects the drive unit to the at least one contact element, which comprises a switching module for the drive unit and a microprocessor module for controlling and/or regulating the switching module,
wherein the method comprises:
determining an interruption of a communication connection with the at least one supply device by the microprocessor module;
switching at least one switching unit of a current-limiting and/or voltage-control module of the intermediate circuit, in order to switch at least one contact element for transmitting electrical energy on the tool side to a voltage-free state;
impressing a current present in the intermediate circuit into the drive unit in order to discharge the intermediate circuit.

12. (canceled)

13. The method according to claim 11, comprising:
identifying a disconnection of the at least one supply device by the microprocessor module depending on at least one defined operating information; and
switching the at least one switching unit by the microprocessor module at least before the current present in the intermediate circuit is impressed into the drive unit.
